(19) United States
(12) Patent Application Publication
(10) Pub. No.: US 2007/0236029 A1
(43) Pub. Date: Oct. 11, 2007

(54) Multi pitch slider

(76) Inventor: Dominick Piccininni, Oakdale, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/784,005

(22) Filed: Apr. 5, 2007

Related U.S. Application Data
(60) Provisional application No. 60/790,190, filed on Apr. 7, 2006.

(51) Int. Cl. B66C 1/42

(52) U.S. Cl. 294/87.1

(57) ABSTRACT

The present invention is a unique pick-and-place gripper used as part of an automated machinery process. The invention includes one or more adjustable, movable grippers that are provided on a support arm and used to transfer items from one location to another. A set of selectively sized spacers may be placed between the grippers to define a first set of positions for the grippers, used at the time objects are picked up (or dropped off). A set of selectively positioned stops are used to define a second set of positions for the grippers, used at the time objects are dropped off (or picked up). Each gripper is equipped with an appropriate actuation device that moves with that gripper and independently of the other grippers to grasp an object. Controls are provided to actuate the grippers when they are positioned to pick up objects, to maintain activation as the arm moves the grippers so that they retain the grasped objects, and to deactivate the grippers when they arrive at an object placement location in order to release the objects. The invention also includes methods of use.

This application claims the benefit of U.S. Provisional Application No. 60/790,190 filed on Apr. 7, 2006, which is incorporated herein by this reference.

### BACKGROUND OF THE INVENTION

1. Field of the Invention

The present invention relates to pick-and-place grippers used as part of an automated. machinery process. In particular, the present invention is directed towards an apparatus having one or more adjustable, movable grippers that are used to transfer items from one location to another, the gripper being capable of expanding or contracting into multiple or adjustable pitches (distances between the items or objects to be picked up or dropped off) for each of the two locations, and related methods.

2. Description of the Prior Art

Numerous automated machines and processes have been developed over time in which items, objects or products must be transferred from one location to another, such as, for example, the removal of items from a tray, rack or box and placement of the items into a machine for processing. Such devices are commonly referred to as “pick-and-place” grippers because they pick up an object from one location and place the object at another location. In many situations, proper placement of the items is critical so that they may be appropriately processed by a machine, which may, for example, apply labels to the items, fold or close the items, fill and seal the items, make incisions or cuts to the items, collect and wrap the items, etc. It is to be appreciated that if items are not properly placed into the machine, they may not be correctly processed leading to rejects and waste, potential jamming of the machine and the like. Thus, it is desirable that “pick-and-place” grippers be capable of precisely removing and placing the items, objects or products.

Some single-unit and stationary-pitch pick-and-place gripping units in existence. Single-unit grippers are inherently inefficient since only one item, object or product may be moved (grasped, transported and placed) at a time. For the purposes of efficiency, it is preferable to process incoming items, objects or products in groups, instead of processing each item one at a time. Stationary-pitch grippers deposit the items in the same positions that they were picked up, which is not always desirable. In addition, the items to be processed may not always be provided in a condition that makes them easy to transfer into a machine. They may be provided in gross, requiring them to be sorted and aligned prior to being picked up. Even if the items are provided in a more uniform condition, such as in a tray, rack or box, the position, placement and distances between the items may not be the same as that required by the machine for proper processing.

It is therefore desirable to provide a “pick-and-place” gripper that is capable of grasping two or more incoming objects at the same time, adjusting the gripping mechanism between a first position needed to grasp the incoming items, and a second position needed for proper placement of the items in a machine for processing.

### SUMMARY OF THE INVENTION

The multi-pitch sliding gripper of the present invention provides a unique “pick-and-place” device that is capable of grasping multiple objects having a first spacing between them, and depositing those grasped objects with the same or different spacing. The invention includes a movable support arm having two or more (as many as 10) movable grippers movably mounted thereon. The arm is designed to move from a first position where it picks up the objects to a second position where it releases or places the objects. The grippers may be provided in any suitable size from miniature to large, and in any suitable form such as vacuum cups, pneumatic, magnetic, static electricity, etc. depending upon the nature of the objects to be picked up. The grippers are attached to support brackets that are slidably mounted on the arm. This configuration allows the support brackets slide from one end of the arm to the other, carrying the grippers with them. Each of the grippers is equipped with an appropriate actuation device that moves with that gripper and independently of the other grippers, such as an air hose, electrical cable, or the like. Controls are provided to actuate the grippers when they are positioned to pick up objects, to maintain activation as the arm moves the grippers so that they retain the grasped objects, and to deactivate the grippers when they arrive at an object placement location in order to release the objects.

In one embodiment, one or more lateral rod members or guides are provided that extend along the length of the arm partially defining the path along which the gripper support brackets slide. In this embodiment, the gripper support brackets are slidably disposed over these rod members along this path. Biasing members such as springs are provided between the brackets urging them apart from each other and away from the distal end of the path. Recesses are provided in each of the brackets to receive the springs when compressed so that the brackets may be pushed flush against each other using pneumatic or mechanical pressure leaving no gap between brackets. This pressure is supplied at one end (a proximal end) of the support arm, and is capable of pressing the brackets together against the opposite end (the distal end) of the arm.

In this embodiment, a first set of movable stops, blocks or spacers are provided in the arm along the slidable path of the gripper support brackets, the spacers being provided on one or more sides of (or in between) each bracket. In on embodiment, the removable slidable spacers are also deployed on the lateral rod members on one or more sides of (or in between) the gripper support brackets. When the gripper support brackets are compressed together along the path, each spacer defines a gap or space between adjacent gripper support brackets, or between an end bracket and the end of the path. This configuration (gripper support brackets and selectively sized spacers) defines a first set of positions for the grippers, used at the time objects are picked up (pitch in). It is to be appreciated that the lengths of the gaps between grippers may be varied greatly, according to the size (width) of the spacers selected and used. It is also to be appreciated that the spacers need not all be of the same or uniform size, but that different sized spacers (or no spacers) may be used between different gripper support brackets according to the gripper position: desired when the gripper support brackets are compressed together. Similarly, the distance between the endmost support bracket and the end of the path may also be defined by different sized spacers, or using no spacer at all.

A second set of movable stops, blocks or spacers are also provided in the arm along the slidable path of the gripper support brackets. When secured in place, these stops define a second set of positions for the grippers, used at the time objects are delivered or released (pitch out). The positions of these delivery stops may be changed according to the desired positions of the grippers at delivery, and need not be uniform or regular. In one embodiment, these delivery stops are provided at different locations along one or both of the outside edges of the arm. It is to be appreciated that when these delivery stops are provided on both sides, they are deployed in pairs having parallel positions.

In one embodiment, the delivery stops extend inward such that they protrude into the path of the support brackets carrying the grippers. Each delivery stop (or pair of stops, when provided on both sides) extends a different distance into the path, these extensions gradually increasing from one end of the arm to the other. In particular, the stop (or pair of stops) deployed at the distal end of the support arm protrude only a short distance into the path. The next set of stops protrude inward a greater distance, the next set an even greater distance, and so on, with the last set of stops (those closest to the proximal end of the arm) extending inward the greatest distance. The slidable support brackets are each provided with recesses or cut-out slots of different graduated depths, the slots being located at positions on the brackets that correspond to points of contact with the delivery stops. The bracket deployed at the distal end of the arm has the smallest (or no) cut-out slot(s), such that when pressure is released and the biasing member urges this bracket towards the proximal end of the arm, the first set of stops (which extend inward only a short distance) prevent it from traveling further. The next bracket has slightly larger cut-out slot(s) that are large enough to pass over the first set of stops, but which are prevented from further travel by the second set of stops because of their greater inward extension into the path. The next bracket has even larger cut-out slot(s) that are large enough to pass over both the first and second set of stops, but which are prevented from further travel by the third set of stops because of their even greater inward extension into the path. This pattern is repeated until the last bracket which has the largest cut-out slot(s), the movement of which is prevented by stops having an even larger inward extension. It is to be appreciated that the stops and slots may be provided on the brackets on their tops, bottoms, left sides, right sides, or any combination thereof.

In use, a set of spacers are selected and placed between the gripper brackets to establish the spacing in the first position (pick up pitch) under pressure. A set of stops are attached at desired locations along the arm to establish the spacing in the second position when pressure is released (delivery pitch). When the gripper mechanism of the present invention is at rest and no pressure is applied, the biasing members between the gripper brackets push them apart and away from the distal end of the arm. The movement of each bracket is arrested by one of the graduated delivery stops that extends inward far enough to prevent further movement of the particular bracket. The brackets (and their associated grippers) at rest are in this second position. Pressure is then applied to the brackets from one end of the arm, compressing the brackets and selected spacers together. The compressed brackets and spacers are now in the first position, ready to pick up the items. The grippers are brought into contact with the items, and the gripping mechanism (vacuum, magnet, etc.) is activated to grip the items. The arm then moves, carrying the items with it to a delivery location. Pressure on the brackets is released at or before the arm reaches the delivery location, allowing the brackets to move to their second positions. The grippers are then deactivated (vacuum or magnet removed) releasing the items according at these positions. The arm is then moved back to the pick up location, pressure is again applied moving the grippers to the first,position, a next set of items are picked up, and so on, in continuous cycles.

It is to be appreciated that the first and second positions of the grippers may be reversed, such that the released position of the grippers may be used at the time the items are picked up, and the compressed position of the gripper used at the time the items are delivered.

### BRIEF DESCRIPTION OF THE DRAWINGS

FIG. 1 is a cross-sectional side view of one embodiment of the present invention.

FIG. 2 is a cross sectional top view of one embodiment of the present invention.

FIG. 3 is a cross sectional bottom view of one embodiment of the present invention.

FIG. 4 is a cross sectional end view of one embodiment of the present invention.

FIG. 5 is cross sectional opposite end view of one embodiment of the present invention.

FIG. 6 is a cross sectional side view of an embodiment of the invention showing the slider energized and compressed.

FIG. 7 is a detailed top sectional view of one embodiment of the present invention. 10 FIG. 8 is a detailed side sectional view of one embodiment of the present invention.

FIG. 9 is cross sectional side view of the invention along line A-A of FIG. 7.

FIG. 10 is cross sectional side view of the invention along line B-B of FIG. 8.

FIG. 11 is a detailed bottom sectional view of one embodiment of the present invention.

FIG. 12 is a detailed sectional end view of one embodiment of the present invention.

FIG. 13 is a detailed sectional opposite end view of one embodiment of the present invention.

### DETAILED DESCRIPTION

It is to be appreciated that the present invention is not limited to the specific exemplary embodiment that is described and illustrated here, and that this embodiment is provided by way of illustration and example only.

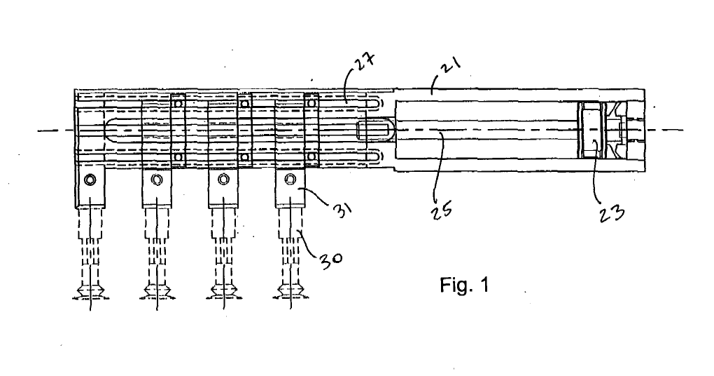

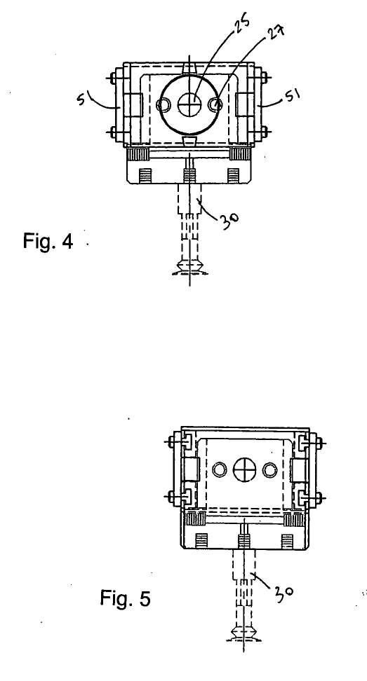

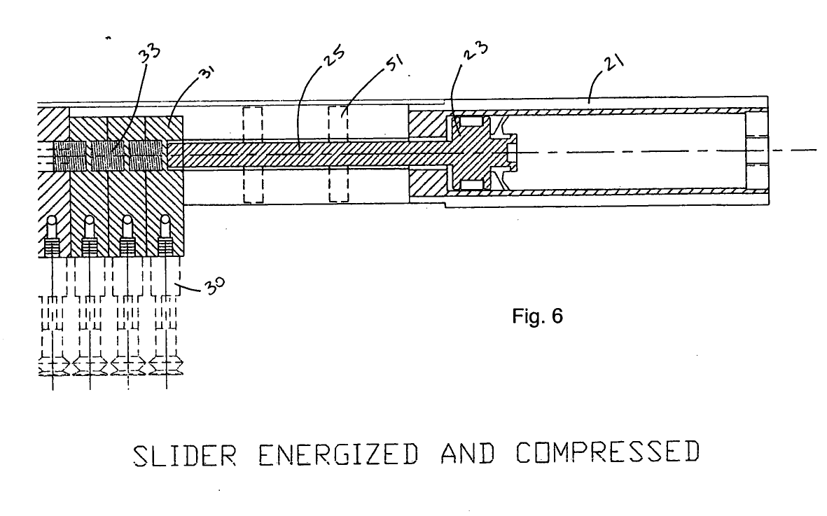

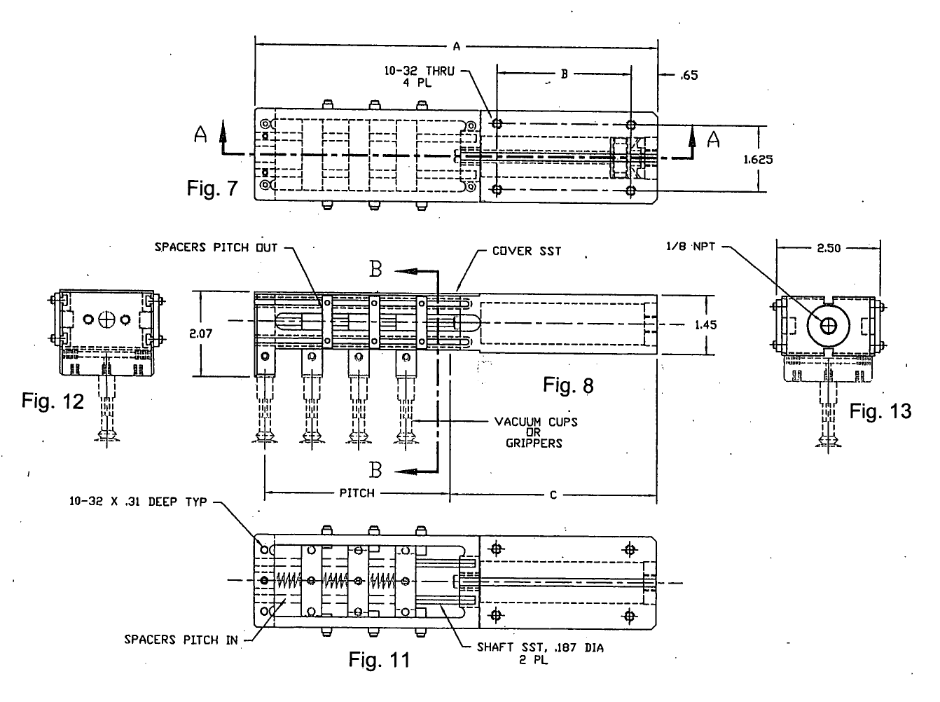

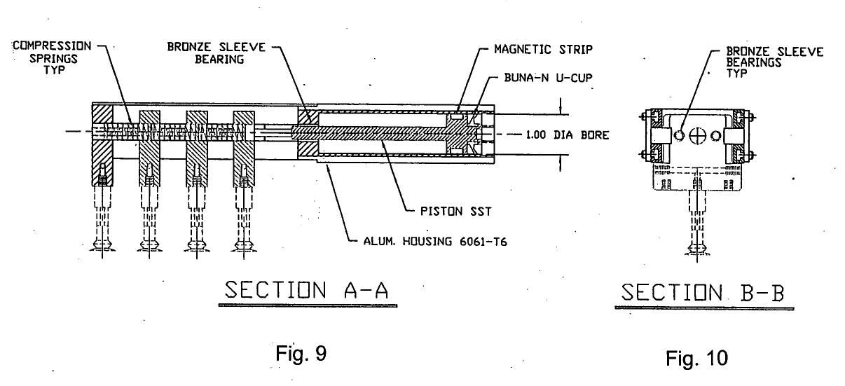

Referring to the drawings wherein the same reference numeral may be used to designate different parts throughout the several views, and referring first to the illustrative example of FIGS. 1-5, it is seen that the arm 21 of the present invention includes a proximal end having a slidable piston structure 23 attached to a pneumatic, air or mechanical pressure source (not shown). Piston 23 is attached to a rod 25 having a length that is about half the length of the arm 21. When pressure is supplied from the source, piston 23 moves into arm 21 extending the rod 25 toward the distal end thereof. See FIG. 6.

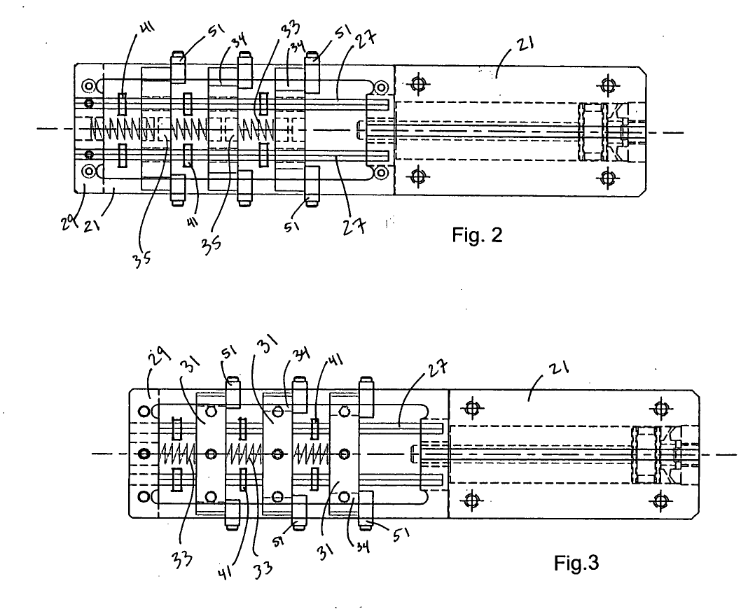

One or more support rods 27 are provided in arm 21 defining a path along which slidable gripper support brackets 31 may travel. Openings or other means are provided in each bracket 31 to allow travel along rods 27. A pneumatic, suction, magnetic or other gripper 30 is provided on each bracket 31 for temporary engagement with an item to be picked up and dropped off. At least one biasing member such as a spring 33 is provided between each bracket 31. Recesses 35 are provided in each gripper (shown in phantom lines in FIG. 2) for receiving springs 33 so that brackets 31 may be pressed flush against each other.

One or more spacers 41 may be provided along rods 27 between brackets 31 defining gaps between said brackets when they are compressed together under pressure from rod 25. Spacers 41 may or may not be provided between each bracket 31, or the endmost bracket and the end wall 29 of the support arm, and each spacer 41 may be of any selected width defining the size of the gap between adjacent brackets 31 (or end wall 29). Thus, when pressure is applied by rod 25, brackets 31 are compressed together but separated from each other and end wall 29 by spacers 41, thereby defining a first set of positions for grippers 30.

One or more stops 51 may also be provided along the edges of support arm 21. Stops 51 may be provided along arm 21 at the top, bottom, first side, opposite side, or combinations thereof. Each stop 51 extends a distance into the central path of arm 21 along which brackets 31 slide. The stops 51 at the proximal end 29 of arm 21 extend the shortest distance into this path, with the next adjacent stops 51 extending a greater distance, and so on, with the stops 51 closest to the piston 23 extending the greatest distance, as shown in FIGS. 2 and 3. Brackets 31 are each provided with slots 34 of different graduated depths located at positions on the brackets that correspond to points of contact with the stops 51. The slots 34 on the bracket 51 closest to the proximal end 29 of arm 21 are very small (or non-existent) such that the first set of stops 51 (which protrude inward only a small distance) prevent this bracket from moving further away from wall 29. The slots 34 on the next bracket 51 are larger, and capable of moving past the first set of stops 51, but this bracket is prevented from moving further away from wall 29 by the next set of stops 51 which extend further in. Similarly, the remaining brackets 31 have gradually larger slots 34 that pass over the previous stops, but are arrested by a subsequent stop. Thus, when pressure is released from rod 25, biasing springs 33 urge brackets 31 apart from each other and end wall 29, the motion of each bracket being prevented by one of stops 51 thereby defining a second set of positions for grippers 30.

It is to be understood that variations and modifications of the present invention may be made without departing from the scope thereof. It is also to be understood that the present invention is not to be limited by the specific embodiments, components or parts disclosed herein, nor by any of the exemplary dimensions set forth in the attached illustrations.

What is claimed is:

1. An adjustable gripping apparatus for picking up and placing objects comprising a movable arm, a plurality of support brackets movably deployed in a channel on said arm, each such bracket supporting an independently activated gripper device, at least one spring provided between adjacent brackets for urging said brackets apart, a pressure imparting device for compressing said brackets together, and at least one removable stop provided on said arm, each such stop extending a distance into said channel.

2. The gripping apparatus of claim 1 wherein at least one removable spacer is provided between adjacent brackets.

3. The gripping apparatus of claim 1 wherein said pressure imparting device includes a rod member.

4. The gripping apparatus of claim 1 wherein each adjacent bracket has a slot for receiving said spring that allows such brackets to make contact with each other over said spring.

5. The gripping apparatus of claim 1 wherein said stops are provided in gradually increasing sizes extending for gradually increasing distances into said channel, and each of said brackets is provided with at least one slot corresponding to the position of said stops, the slots on adjacent brackets being of gradually increasing sizes.

6. A method of picking up and placing objects comprising the steps of:
a. establishing a first set of positions for a plurality of movable grippers slidably deployed on a movable support arm;
b. establishing a second set of positions for said plurality of grippers by providing at least one stop on said arm;
c. compressing said grippers together to place them in said first set of positions;
d. moving said arm so that it is adjacent to an incoming set of items;
e. activating said grippers such that they grasp a group of said items;
f. moving said arm to a second location where said items are to be deposited;
g. expanding said grippers apart to place them in said second set of positions; and
h. deactivating said grippers such that they release said group of items.

7. The method of claim 6 comprising the additional step of inserting at least one spacer between said grippers.

8. A method of picking up and placing objects comprising the steps of:
a. establishing a first set of positions for a plurality of movable grippers slidably deployed on a movable support arm;
b. establishing a second set of positions for said plurality of grippers by providing at least one stop on said arm;
c. expanding said grippers apart to place them in said first set of positions;
d. moving said arm so that it is adjacent to an incoming set of items;
e. activating said grippers such that they grasp a group of said items;
f. moving said arm to a second location where said items are to be deposited;
g. compressing said grippers together to place them in said second set of positions; and
h. deactivating said grippers such that they release said group of items.

9. The method of claim 8 comprising the additional step of inserting at least one spacer between said grippers.
